(19) United States
(12) Patent Application Publication
(10) Pub. No.: US 2007/0083416 A1
(43) Pub. Date: Apr. 12, 2007

(54) SYSTEM ARCHITECTURE FOR SCHEDULING AND PRODUCT MANAGEMENT

(76) Inventor: Mikhail Yury Podrazhansky, Alpharetta, GA (US)

Correspondence Address: POWELL GOLDSTEIN LLP, ONE ATLANTIC CENTER, FOURTEENTH FLOOR 1201 WEST PEACHTREE STREET NW, ATLANTA, GA, 30309-3488, US

(21) Appl. No.: 11/382,333

(22) Filed: May 9, 2006

Related U.S. Application Data
(63) Continuation of application No. 10/016,364, filed on Oct. 30, 2001, now abandoned.
(60) Provisional application No. 60/244,466, filed on Oct. 31, 2000.

(51) Int. Cl. G06F 9/46

(52) U.S. Cl. 705/9

(57) ABSTRACT

A modular system architecture for a process stream generating historical work transactional data. The data are received by a system Data Import Module. The Data Import Module transforms the historical work transactional data into at least one Workload Volume. A Forecast Module in communication with the Data Import Module receives a selected Workload Volume and projects a future workload demand or Forecasted Workload Volumes derived from a selected search algorithm. A Staffing Requirements Module in communication with the Forecast Module receives a selected Forecasted Workload Volume. The Staffing Requirements Module has a plurality of Staffing Guide functions applying staffing constraints that drive the Forecasted Workload Volume. A Scheduling Module in communication with the Staffing Requirements Module receives a selected Staffing Requirements and transforms the Staffing Requirements into a schedule viewable by a user.

### CROSS REFERENCE TO RELATED APPLICATION

This is a continuation application of co-pending U.S. application Ser. No. 10/016,364, filed Oct. 30, 2001, which claims the benefit of copending U.S. Provisional Application No. 60/244,466, filed on Oct. 31, 2000, the disclosures of which are incorporated herein.

### FIELD OF THE INVENTION

The invention relates, in general, to a system for scheduling and project management of a process stream. In particular, the invention relates to a modular system architecture for commanding and controlling the scheduling and project management of a process stream.

### BACKGROUND OF THE INVENTION

Historically, computer assisted scheduling and project management were accomplished in one of three ways. The simplest computer assisted schedule uses the computer as a storage medium. All entries and decisions concerning the schedule are made by a user and then entered into the computer. A more advanced computer assisted scheduling and project management tool is a system that enables the user to make partial entries into a schedule, and the computer generates the remaining entries. A still more advanced computer assisted scheduling and project management tool is a system that enables the user to make complex entries into a schedule, and the computer resolves the complex entries into a schedule.

Each of the above discussed computer assisted scheduling and project management tools have a common thread running through them. The common thread is that they all are tightly focused on a particular aspect of scheduling and project management.

Attempts in the past were made to broaden the scope of scheduling and project management tools. One attempt suggests a Task Management Program or system that is aided graphically by a technique in which a workload quantity associated with each task is represented by a geometric object of at least two dimensions. The geometric area or volume of a principal object is indicative of the quantity of data contained within the principal object that is displayed on a computer monitor. The data contained in the viewed principal object or the associated data changes in dependent objects graphically increases or decreases the geometric volume of the principal object. For example, a change in geometric volume of the principal object's relative rectangular length corresponds to the time required to perform a given task. The system is interactive meaning a user may adjust the task loading to produce larger or smaller objects indicating total task loading.

Another attempt to broaden the scope of scheduling and project management tools is a tool for an automatic telephone call distribution system. Routing of telephone calls is derived from periodic real time data that gives correct queue size and number of agents (telephone marketers) per each site, i.e., the telephone call center. The system is continuously updated based on telephone call volume. Between updates, the status of each agent at each site is evaluated, i.e., telephone calls in process and total number of telephone calls waiting a response by the agent. The system forecasts the amount of local traffic or telephone calls associated with a particular agent and makes decisions as to the loading of a particular agent with incoming or outgoing telephone contact.

While the two discussed attempts broaden the scope of scheduling and project management, they still are tightly focused on specific industries that require special attributes or conditions applied to scheduling and project management for their environment. For example, a project and management scheduling tool developed for an automatic telephone call distribution system could not be used in a chemical processing or manufacturing environment without extensive redevelopment. The attributes and conditions of the exemplary systems are not interchangeable. What exists in the automatic telephone call distribution industry does not exist in chemical industry.

It would be desirable to have a scheduling and project management system that is flexible and could be implemented across industries with various requirements, conditions and attributes. The system would have an architecture that would focus on a process stream encompassing multidiscipline industries. The system architecture would implement the fundamental precepts of planning, organizing and implementing the plan. The fundamental precepts that exist across multidisciplinary industries manifest themselves in workload, time and cost required to execute the workload and the labor force required to perform work. The system architecture would be modular in concept enabling an individual company in a particular industry to seamlessly add specific modules to accommodate specific needs presented in the company. Further, the system architecture modules would transform attributes, constraints and needs of the company, manifested in workload transaction data, into a forecasted workload of time required to execute the workload, labor force required to perform the workload and the cost of implementing the forecasted workload.

### SUMMARY OF THE INVENTION

The present invention is a modular system architecture for a process stream. The process stream has means operatively disposed therein for communicating with at least one computer or database engaged in management of workload distribution. The system has a plurality of modules seamlessly and interactively connected together. The modules have data structures formulated into functions that command and control the operational features of the present invention.

The present invention is in communication with the computer or database and receives a data stream delineating historical work transactional data or queued data via a Data Import Module. The Data Import Module transforms the historical work transaction data into at least one Workload Volume. The Workload Volume delineates the historical work transactional data over a selected time period or historical work transaction data modified to reflect special events that may influence the projected work transactional data in the future. A Forecast Module in communication with the Data Import Module receives a selected Workload Volume and projects a future workload demand or Forecasted Workload Volumes derived from a selected search algorithm. If desired, the selected Workload Volume may delineate actual historical work transactional data modified by special events. If desired, queued data may be transmitted to the present invention. The queued data are organized in a predetermined sequence. The Data Import Module receives the queued data via a Data Import function. The Data Import function processes the queued data and generates a Workload Volume via an Actual Queue Data function.

A Staffing Requirements Module in communication the Forecast Module receives a selected Forecasted Workload Volume. The Staffing Requirements Module has a plurality of Staffing Guide functions that apply staffing constraints that are driven by the Forecasted Workload Volume. The staffing constraints may, if desired, be monetary, time, availability of labor force and premiums associated the constraints. After applying the aforementioned constraints, the Staffing Requirements Module transforms the resulting data into a Staffing Requirements.

A Scheduling Module in communication with the Staffing Requirements Module receives a selected Staffing Requirements and transforms the Staffing Requirements into a schedule viewable by a user. A Tool Module and Scheduling Costing Module in communication with the Scheduling Module have a plurality of tools to manage the cost of and manipulate entries made on the schedule derived from the Scheduling Module.

When taken in conjunction with the accompanying drawings and the appended claims, other features and advantages of the present invention become apparent upon reading the following detailed description of the embodiments of the invention.

### BRIEF DESCRIPTION OF THE DRAWINGS

The invention is illustrated in the drawings in which like reference characters designate the same or similar parts throughout the figures of which:

FIG. 1 illustrates a top level block diagram view of the preferred embodiment of the present invention,

FIG. 2 illustrates a detailed block diagram view of the Data Import Module of FIG. 1,

FIG. 3 illustrates a detailed block diagram view of the Forecast Module of FIG. 1,

FIG. 4 illustrates a flowchart diagram view of the Search Algorithm function of FIG. 3,

FIG. 5 illustrates a detailed block diagram view of the Processing The Forecast function of FIG. 4,

FIG. 6 illustrates a detailed block diagram view of the Staffing Requirements Module and Scheduling Module of FIG. 1,

FIG. 7 illustrates a detailed block diagram view of the Tool Module of FIG. 1,

FIG. 8 illustrates a detailed block diagram view of the Costing Modules of FIG. 1,

FIG. 9 illustrates a detailed block diagram view of the Raw Data Import of FIG. 1,

FIG. 10 illustrates a detailed block diagram view of the Selected Conditions Calendar—Historical Data Import of FIG. 2,

FIG. 11 illustrates a detailed block diagram view of the Selected Conditions Calendar—Queue Data Import of FIG. 2,

FIG. 12 illustrates a detailed block diagram view of the Special Events and Special Event Data of FIG. 2.

### DETAILED DESCRIPTION OF THE INVENTION

Before describing in detail the particular improved modular system architecture for a process stream in accordance with the present invention, it should be observed that the invention resides primarily in the novel integration of various aspects of the scheduling and project management industry. The present invention further resides in the unique data structures of the system software and not in the combination of conventional system apparatus. Examples of system apparatus include computers, computer networks of various types, telephone networks, PBX systems or a communication system linking the system apparatus by a local area network, wide area networks, or Internet networks.

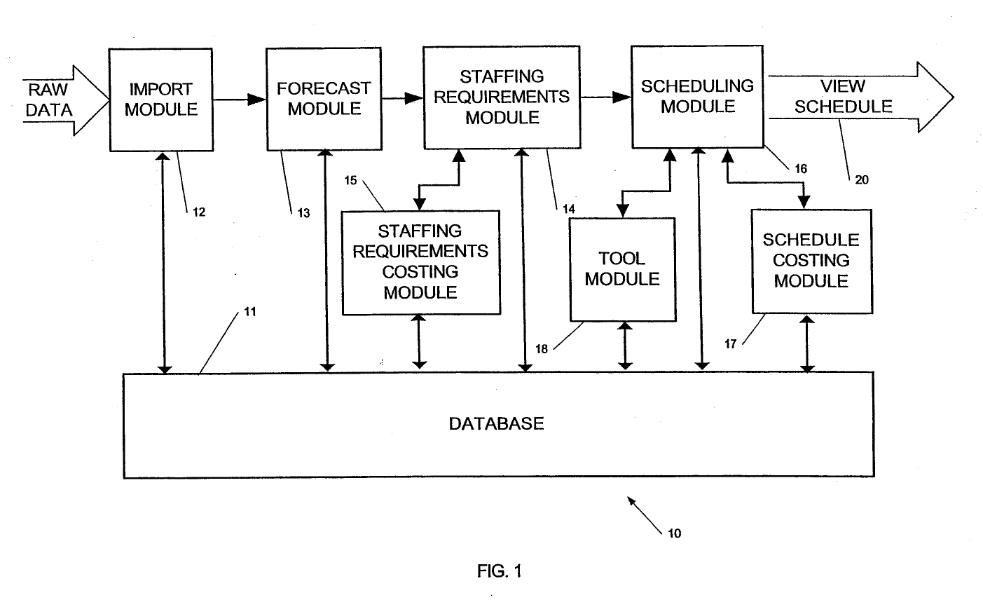

The present invention 10, FIG. 1, may, if desired, be implemented by any combination of convenient hardware components or software programming language consistent with the precepts of the present invention or by any known mean to those skilled in the art. The present invention 10 may, if desired, be programmed in any suitable programming language known to those skilled in the art. An example of a programming language is disclosed in C Programming Language, 2/e, Kernighan & Richtie, Prentice Hall, (1989). The integration of software aspects with hardware components of the present invention is delineated herein.

The invention is not in the particular detailed configuration of the system apparatus but in the system integration or command and control thereof. Accordingly, the data structures, command, control, and arrangement of the present invention have, for the most part, been illustrated in the drawings by readily understandable block diagrams and flowcharts. The drawings show only those specific details that are pertinent to the present invention in order not to obscure the disclosure with structural details which will be readily apparent to those skilled in the art having the benefit of the description herein.

An overview of the present invention 10: The present invention 10, FIG. 1 is a modular system architecture for a process stream that accepts raw data provided by a user or data provided by a computer system. The raw data are processed or transformed into a Viewable Scheduling 20 and project management tool. For example, an individual user engaged in scheduling or project management for a selected organization may upload selected data records or files containing pertinent data concerning the operation of the organization for processing. The pertinent data may, if desired, be historical transactions over a selected time period. The pertinent data may, if desired, be individual historical transactional data or blocks of historical transactional data.

The pertinent data transmitted to the present invention 10, FIG. 1, represents activities or work effort performed on the selected organization's behalf. When a plurality of activities or work is performed, a volume of work effort has been expended on the selected organization's behalf or a workload volume(s) has been performed. Receiving the workload volume, the present invention 10, forecasts a prediction of future workload volume(s). The prediction is derived from at least one condition or limitation that is imposed on the forecast by the user. The user imposed condition may, if desired, be a plurality of conditions that affect the forecasted workload volume. The conditions are defined herein as workload drivers, i.e., conditions, once applied, affect the volume of work expended on the selected organization's behalf. For example, the workload drivers may be environmental, i.e., weather, geographical or political. The workload drivers may be individual employees or groups of employees engaged in a plurality of activities related to the workload volume. The workload drivers may be time constrained, i.e., date, time of day, date, day of the week, day of the week of the month, month of the year. The workload drivers may be bushiness related, i.e., materials, supplies availability or structure of the selected organizations. The selected organization(s) referred to herein may, if desired, be global, regional or a plurality of global and regional organization. The selected organization may represent corporate structure as applied to an organization. For example, the corporate structure of an organization is divided into at least one division, department or workgroup. The organization(s) of the present invention 10 is flexible and is defined by the user.

The present invention 10, FIG. 1, derives a staffing requirement that optimally satisfies the forecasted workload volume with consideration or in view of the applied workload volume drivers. The present invention 10 formulates a schedule reflecting the staffing requirement in view of the workload volume drivers. The schedule may, if desired, provide the user with an actual representation of forecasted volume of work and the expected staffing requirements to perform work on the organization's behalf. The user may, if desired, apply a plurality of tools that enable costing of the forecasted volume of work and the expected staffing requirements required to perform work. Further, the user may, if desired, construct and apply a plurality of different scenarios reflecting at least one “what-if” condition. The constructed scenario may, if desired, be derived from actual historical transactions or from any selected condition that may affect the workload volume performed.

Another example, a computer system in communication with the present invention 10, FIG. 1 is an Automatic Call Distribution (ACD) computer system. The ACD controls incoming and outgoing telephone calls to and from prospective recipients of live, prerecorded or a combination of live and prerecorded messages. The ACD provides data records of the transactions between the recipient and all elements associated with the message transaction. The data records are transmitted as raw data via an electronic link to the present invention 10. The raw data are received by the present invention 10 and are processed according to at least one selected scenario, i.e., special conditions applied (as discussed above). The management of the ACD, in communication with the present invention 10, receives a forecasted workload volume schedule derived from actual historical transactions or projected transactions. The management of the ACD may, if desired, implement any or all of the above discussed tools enabling the management to create various types of scenarios.

A more detailed discussion of the present invention 10, follows. The present invention 10 is system integration of a plurality software modules in communication with a Database 11, the individual user and/or the selected computer system. The modules are Data Import Module 12, Forecast Module 13, Staffing Requirements Module 14, Staffing Requirements Costing Module 15, Scheduling Module 16, Scheduling Cost Module 17 and Tool Module 18. All of the aforementioned software modules have logic or data structures that command and control all aspects of the present invention 10.

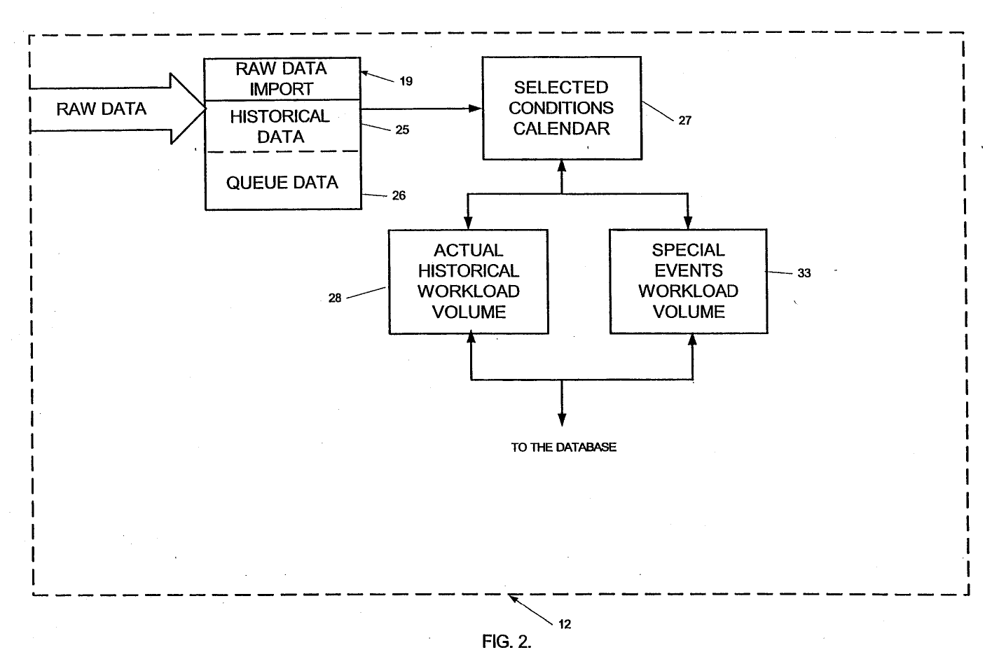

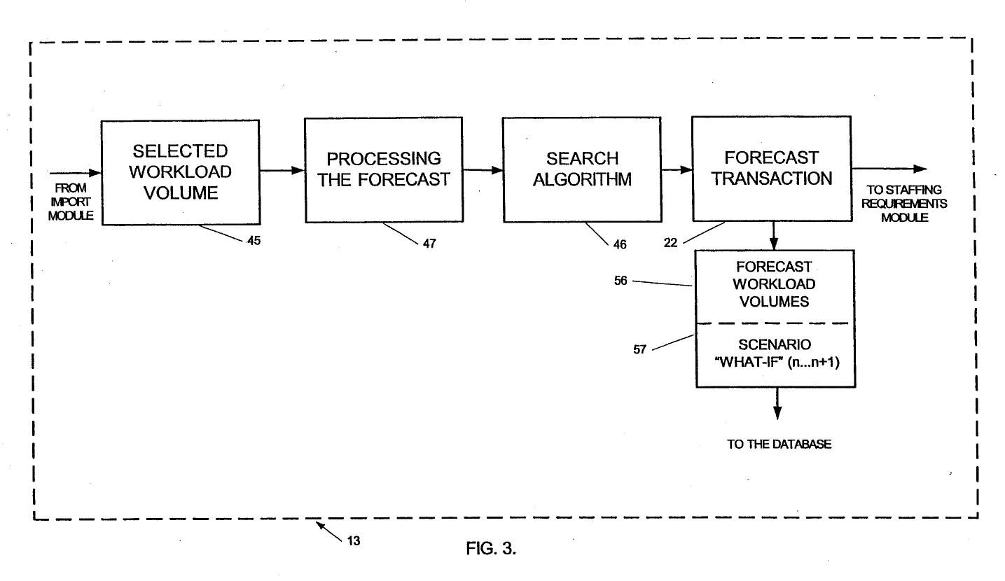

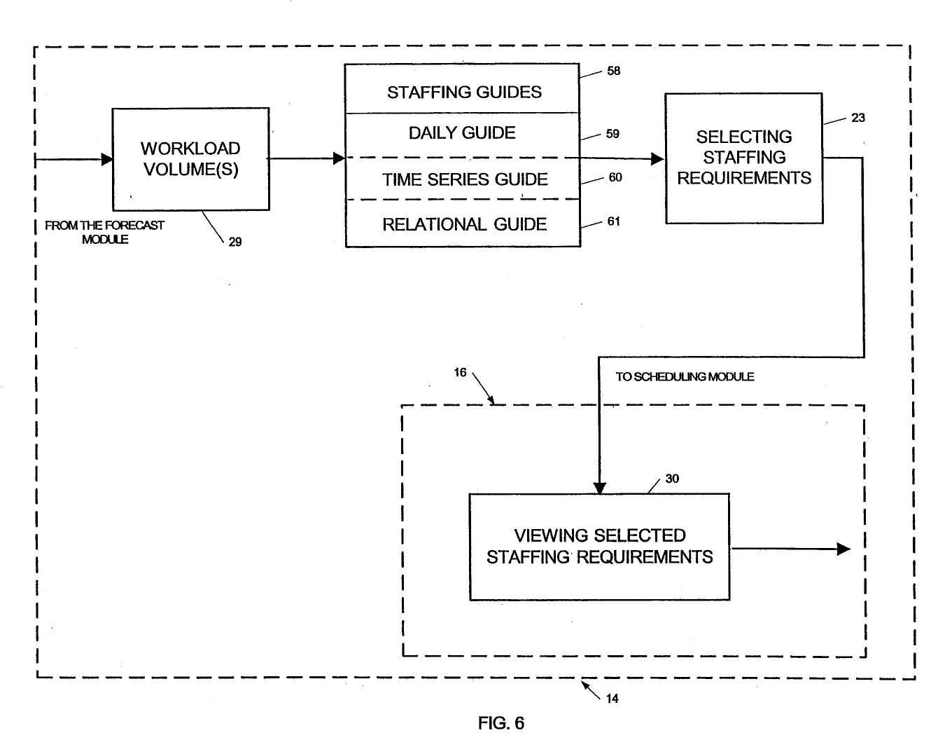

The Data Import Module 12, FIG. 2 receives the Raw Data or the generated historical transactional data from the user and/or selected computer system. The Data Import Module 12 in concert with a Selected Conditions Calendar 27 function transforms the Raw Data into at least one Actual Historical Workload Volume 28 (discussed herein). The Forecast Module 13, FIG. 3 in communication with the Data Import Module 12 receives the Actual Historical Workload Volume 28 and transforms the Actual Historical Workload Volume 28 into a Forecasted Transaction 22. The Staffing Requirements Module 14, FIG. 6 in communication with the Forecast Module 13 receives Forecasted Transaction 22 via a Workload Volumes 29 function. The Staffing Requirements Module 14 transforms the Forecasted Transaction 22 into at least one Staffing Requirements 23, FIG. 6. The result of the user's Selecting Staffing Requirements 23 is accessible and viewable via the Viewing Selected Staffing Requirements 30 function via Scheduling Module 16, FIG. 6. The Scheduling Module 16 in communication with the user and/or the selected computer system presents a viewable schedule or analysis of a project management projection. The Schedule Costing Module 17, FIG. 1 and the Tool Module 18 are in communication with the Scheduling Module 16. The Staffing Requirements Costing Module 15, FIG. 1 in communication with the Staffing Requirements Module 14 enables the user and/or the selected computer system to transform the viewable schedule or analysis of the project management projection into an actual schedule or actual project management projection. If desired, the Schedule Costing Module 17, the Tool Module 18 and the Staffing Requirements Costing Module 15 enable the user and/or the selected computer system to transform the viewable schedule or analysis of the project management projection into a viewable “what-if” schedule or analysis of the project management projection.

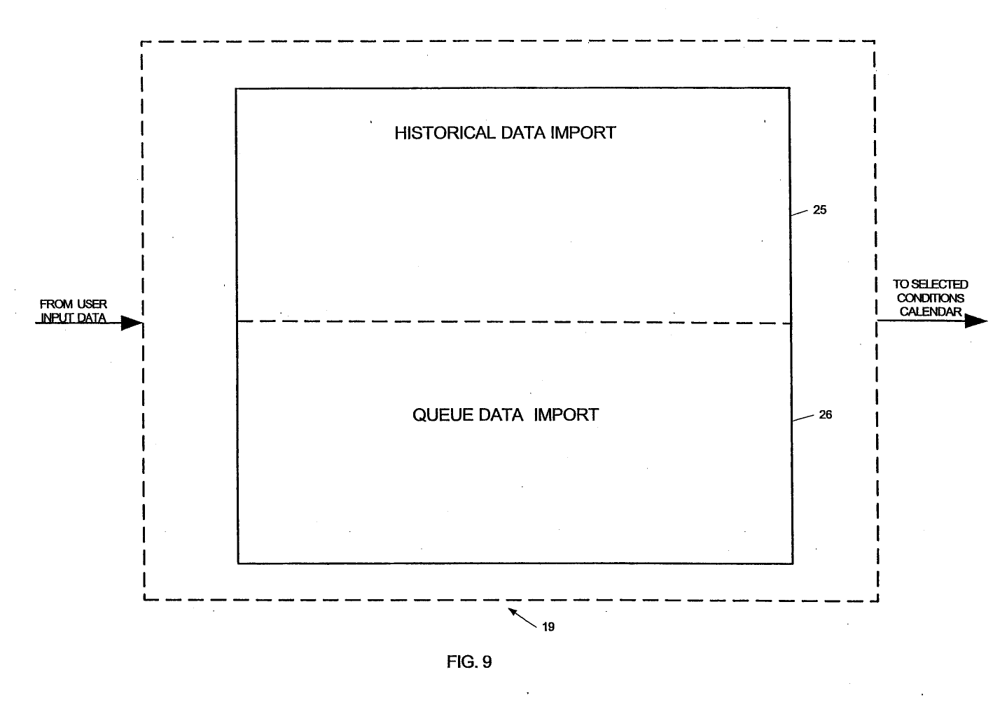

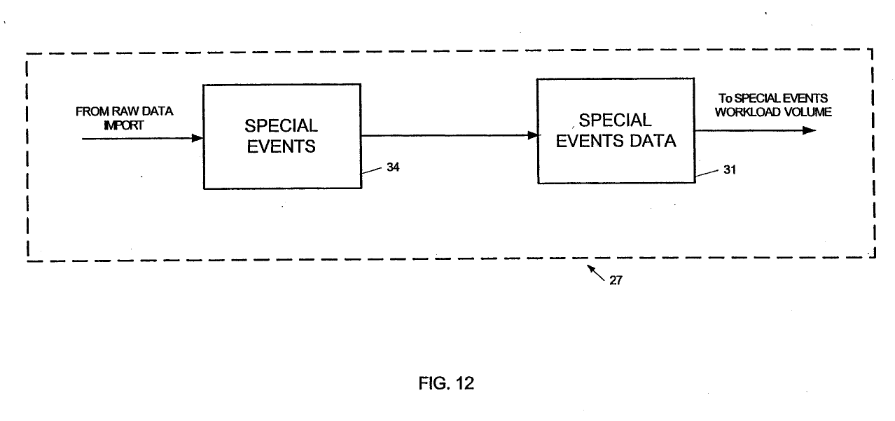

The Data Import Module 12 receives and manipulates raw data via the Raw Data Import 19, FIG. 9 function and in concert with a Selected Conditions Calendar 27 function, transforms the raw data into at least one Actual Historical Workload Volume 28, FIG. 2 or at least one Special Events Data Volume 33. The Raw Data Import 19 receives two types of raw data via a Historical Data 25 function and a Queue Data 26 function. The Special Events Data Volume 33 is derived from a Special Events 31, FIG. 12 function. The Special Events 31 function receives data entries via a user delineating Special Events 34, i.e., historical actions that affect the workload of an organization. For example, historically a telephone call center receives an abnormal volume of calls during a sporting event. The time, date, name and resulting impact to the volume of telephone calls received by the telephone call center is applied to the historical transactional data and stored on Database 11 as a Special Events Data Volume 33.

If desired, the actual historical transactional data received from the user is via the Historical Data 25, FIG. 9 function. The actual historical transactional data may, if desired, be any type of data formatted into a predetermined sequence that reflects the operational structure of an organization of interest. For example, the user is a manufacturing plant engaged in assembly of computers on a plurality of assembly lines. The actual historical transactional data are the performance of the assembly lines producing the computers. The historical transactional data delineates day, date, time, assembler identification and time spent in assembling of computers. The actual historical transactional data are stored on Database 11 as an Actual Historical Workload Volume 28.

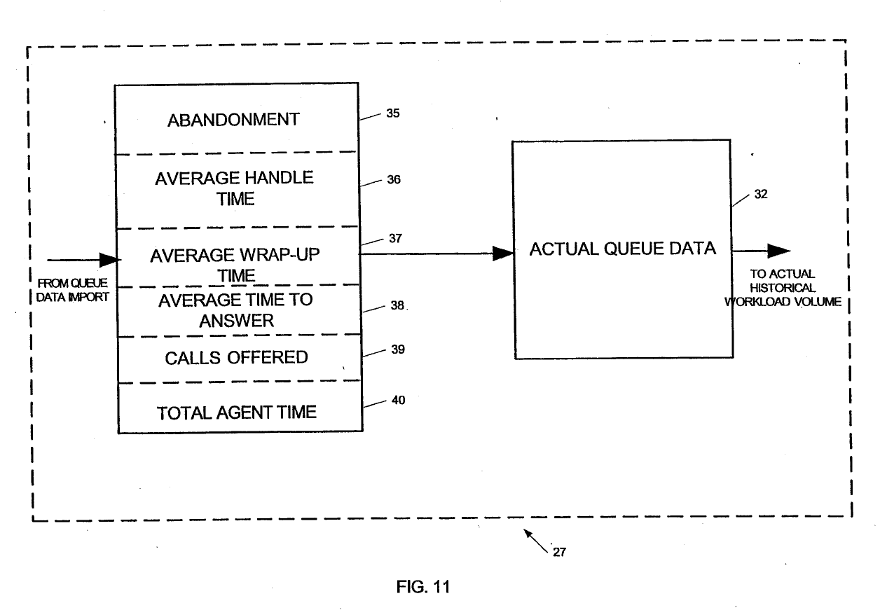

The historical transactions may, if desired, be imported into the present invention 10 via the Queue Data 26, FIG. 9 function. The Queue Data 26 function, unlike the Historical Data 25 function, is configured as a series of selectable workload variables. The Queue Data 26 receives historical transactional data in a predetermined format. If desired, the format reflects the unique operational characteristics or variables of an organization. For example, a telephone call center via its ACD monitors all incoming and outgoing telephone calls. The ACD uploads the data via the Queue Data 26 function. The Selected Conditions Calendar 27, FIG. 11 function in communication the Queue Data 26 function applies selected conditions to the received historical transactional data. If desired, the selected conditions may be the total number of telephone calls abandoned 35, average handling time 36, average wrap-up time 37, average time to answer 38, calls offered 39 or total agent time. Once the selected conditions are applied, the resulting historical data are stored on the Database 11 as Actual Historical Workload Volume 28 via an Actual Queue Data 32 function.

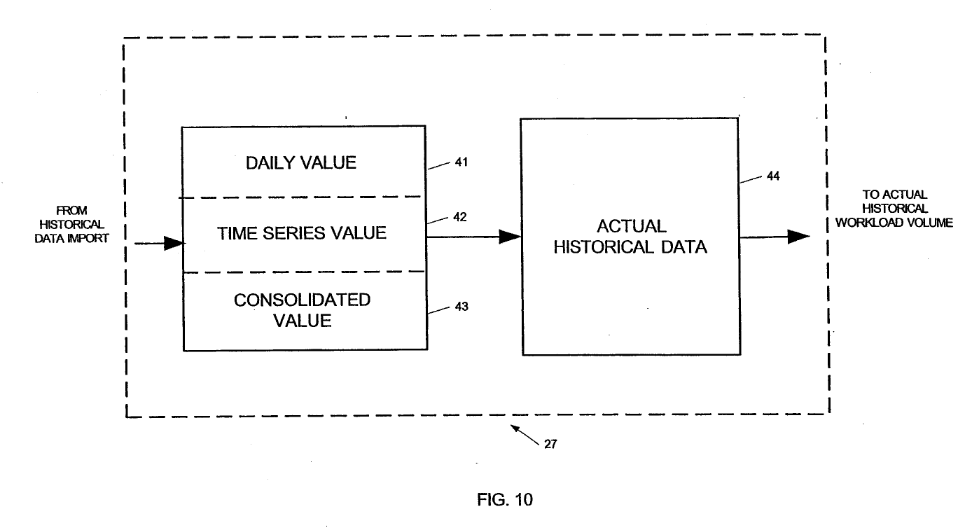

The Selected Conditions Calendar 27, FIG. 2 function may, if desired, receive historical transactional data via the Historical Data 25, FIG. 10 function. The Selected Conditions Calendar 27, FIG. 10 may, if desired, parse the received data in selected groups representing specific types of data fields. The selected groups are daily value 41, time series value 42 and consolidated value 43. The daily value 41 receives parsed data representing the total historical transactional data per day. The time series value 42 receives parsed data representing historical transactional data incrementally through out a day. The consolidated value 43 receives parsed data representing a selected percentage of time series value 42 or daily value 41 historical transactional data. Once the Selected Conditions Calendar 27 applies the selected aforementioned groups to the historical transactional data, the results are stored on Database 11 via the Actual Historical Data 44 function as Actual Historical Workload Volume 28.

The Forecast Module 13, FIG. 3 processes a Selected Workload Volume 45 into a forecast predicting future workload requirements based on historical transactions or events. The Selected Workload Volume 45 may, if desired, be derived from an Actual Historical Workload Volume 28, Special Events Workload Volumes 33 or any other workload volume stored on Database 11.

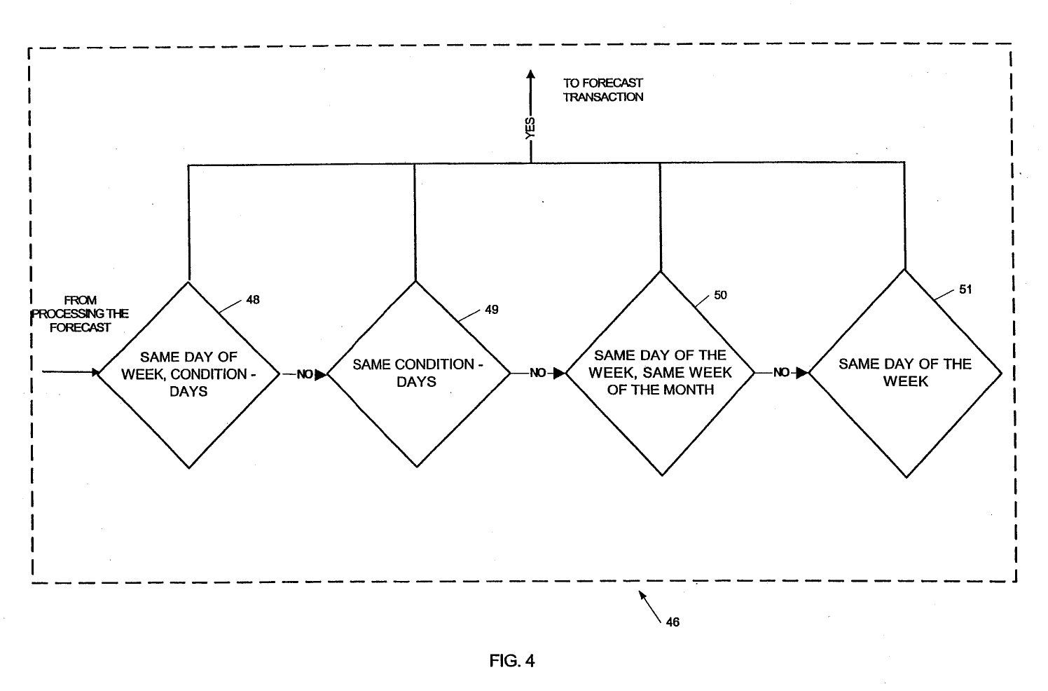

The Forecasting Module 13, FIG. 4 applies a Search Algorithm 46 function according to selectable conditions that define data points of interest or times and dates to search the Selected Workload Volume 45 for a comparable time period. The selectable conditions are preselected via the Processing the Forecast 47 (discussed herein). The time period of the data points of interest may, if desired, be derived from the same day of the week 48, the same day 49, same day of the week same week of the month 50 or defaulted to the same day of the week 51. The criteria used by the Search Algorithm 46 function to resolve the search is determined if the date being predicted has one or more special conditions, such as a special event. If the date does not have any special conditions, the search proceeds to the next condition. A search for other historical dates that have the exact set of special conditions and same day of the week occurs. If only one data point is discovered, it is used as the exclusive predictor for the future data points. If more than one exact point is discovered, the matching data points are found. Once the desired data field is obtained, the Search Algorithm 46 function resolves the desired data field into a rolling average forecast for a selected workload demand.

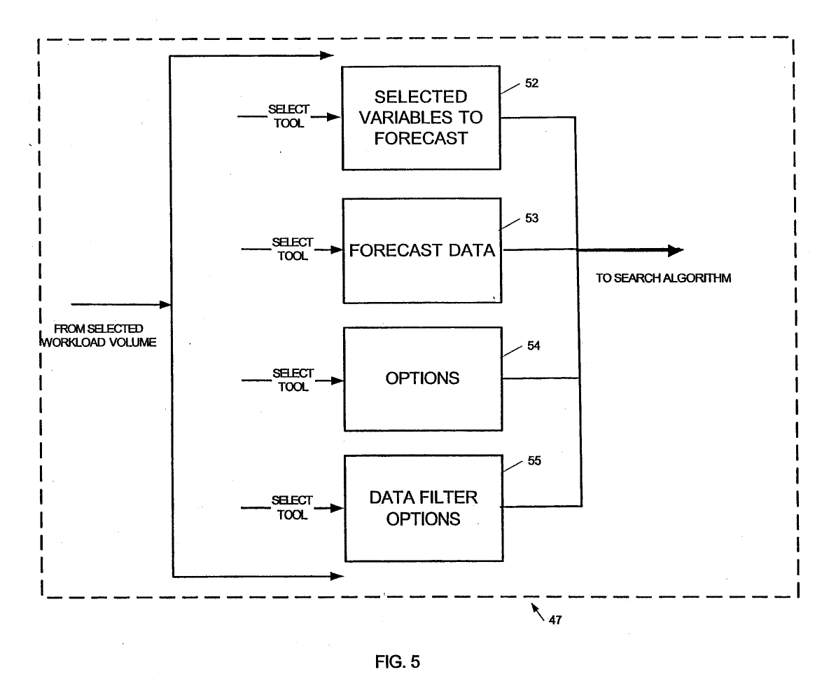

The Processing The Forecast 47, FIG. 5 has a plurality tools to assist the user to conduct various scenarios involving historical transactional data and the effects of projecting the historical transactional data into the future via the Forecast Module 12. The tools are a Select Variables To Forecast 52, Forecast Data 53, Options 54 and Data Filter Options 55. The Select Variables To Forecast 52 has a plurality of selectable options wherein the user may, if desired, select a department or departments of the user's organization that may be affected by the forecast. The options may include, if desired, data contained in an Actual Historical Workload Volume 28, workload drivers or special conditions as discussed above, the destination of the forecasted scenario, i.e., name of the forecasted scenario to be stored in Database 11, forecasted dates, i.e., start date and stop date of the forecasted scenario. The Option 54 tool enables the user to average days, use seasonal data, or trending, create a validation table or a detailed log of the forecasted scenario. The Data Filter Options 55 tool enables the user to discard the greatest deviation from average, exclude values, look for same week of the month and exclude dates prior to a selected date. The Forecast Data 53 tool starts the forecasting process.

The Forecast Transaction 22, FIG. 3 in communication with the Search Algorithm 46 derives a Forecasted Workload Volume 56 or a Selected Scenario 57 based on the selected options and special conditions as discussed above. The Forecasted Workload Volume 56 may, if desired, be the actual forecasted workload based on historical transactional data. The Selected Scenario 57 may, if desired, be derived from actual historical transactional data plus special conditions, i.e., the special conditions enable the user to ascertain a “what-if” type scenario. The results of all forecasts may, if desired, be stored in Database 11.

The Staffing Requirements Module 14, FIG. 6 transforms at least one Workload Volume 29 into Selected Staffing 23 via the Staffing Guides 58. The result of the Staffing Requirements Module 14 activities is viewable via the Viewing Selected Staffing Requirements 30 function generated by the Scheduling Module 16. The Forecast Module 13 has generated a future prediction of an activity or workload. The future prediction delineates the volume of the activity or workload. The Staffing Requirements Module 14 converts workload volumes into the time it takes to complete the task dictated by the workload volume. The workload volume comprises a plurality of activities. Each activity represents individual effort or individual time expended on the activity. A plurality of individuals can be involved in the same activity. The conversion process is implemented by the Staffing Guides 58.

The Staffing Guides 58, FIG. 6 delineate all of the events associated with performance of an individual in the course of performing an activity. The Staffing Guides 58 applies conditions that affect or influence the effort of individuals performing work hence the volume of work or workload volume is effected or influenced. The Staffing Guides 58 may, if desired, be attached to each individual or position the individual occupies. One or many Staffing Guides 58 can exist per position if the position is responsible for more than one activity. The result of the conversion is the amount of time that needs to be scheduled for that position to handle the volumes identified.

The three different but related types of Staffing Guides 58, FIG. 6 are provided to enable the user to resolve the selected forecasted workload, i.e., Daily Guides 59, Time Series Guide 60 and Relational Guide 61. The Daily Guide 59 uses one total value to calculate the amount of time required to perform a selected task. The Daily Guide 59 may, if desired, be set up to use a range of workload volume; 1-100, 101-200, 201-300, for a set amount of staff, or it can calculate the amount of time per unit of volume contained in the daily value. There are four types of Daily staffing guides: Standard, Resource Level, Minimum and Maximum. The Daily Guide's 59 Standard depicting the staffing requirements and illustrating in a bar graph the number of individuals needed to perform a selected task over a selected time period. The number individual may, if desired, be any number of available individuals. The time period may, if desired, be any convenient time period. The Daily Guide's 59 Resource Level contributes floating workload, i.e., individuals that may occupy more than one position or individuals held in reserve to be tasked as needed. The Daily Guide's 59 Minimum ensures a minimum number of individuals or staff required to fulfill the task of the workload volume. The Daily Guide's 59 Maximum restricts the number of individuals or staff to required to fulfill the task of the workload volume.

The Time Series Guide 60, FIG. 6 is a Workload Driver that has a value for each specified time increment in a day. If 1 hour time periods have been specified, the volumes for any hour of the day are summed and then multiplied by the amount of time specified as necessary to handle each unit of volume or range of volumes. Another Workload Driver may be specified as the time value.

The Relational Guide 61, FIG. 6 is derivable via a second selected Staffing Guide 58. The Relational Guide 61 does not generate staffing relations based on its selected work criteria but the selected work criteria of another staffing guide.

The Selected Staffing Requirements 23 receives the Workload Volumes 29 with the applied Staffing Guides 58. The Selected Staffing Requirements 23 formulates the received data into informational packets of data transmittable to the Scheduling Module 16.

The Scheduling Module 16, FIG. 1, receives the data packets from the Selected Staffing Requirements 23 and in concert with the Tool Module 18 and the Schedule Costing Module 17 transforms the received data packets into viewable graphs. The user of the present invention 10 is enabled via the Scheduling Module 16 to view the schedule of workload, staffing requirements and cost of performing or executing a selected task. The Staffing Requirements Costing Module 15 in communication with the Staffing Requirements Module 14 is an instance of the Schedule Costing Module 17. The informational structure of the Schedule Costing Module 17 is directly applicable to the Staffing Requirements Costing Module 15; hence, only the Schedule Costing Module 17 is to be discussed herein.

The Schedule Costing Module 17 has a plurality of tools enabling the user to perform cost analysis on a scheduled workload volume or derive an estimated cost of a workload volume. The Estimated Cost Of A Schedule 63 tool enables the user to generally estimate the cost of a workload volume via making preliminary estimates of work required to fulfill a particular task based on historical information, known labor costs and known labor force availability. The preliminary estimates may, if desired, be “guesstimates”, i.e., costs based on best guess by the user. The preliminary estimates may be revised to reflect a more accurate cost in the future.

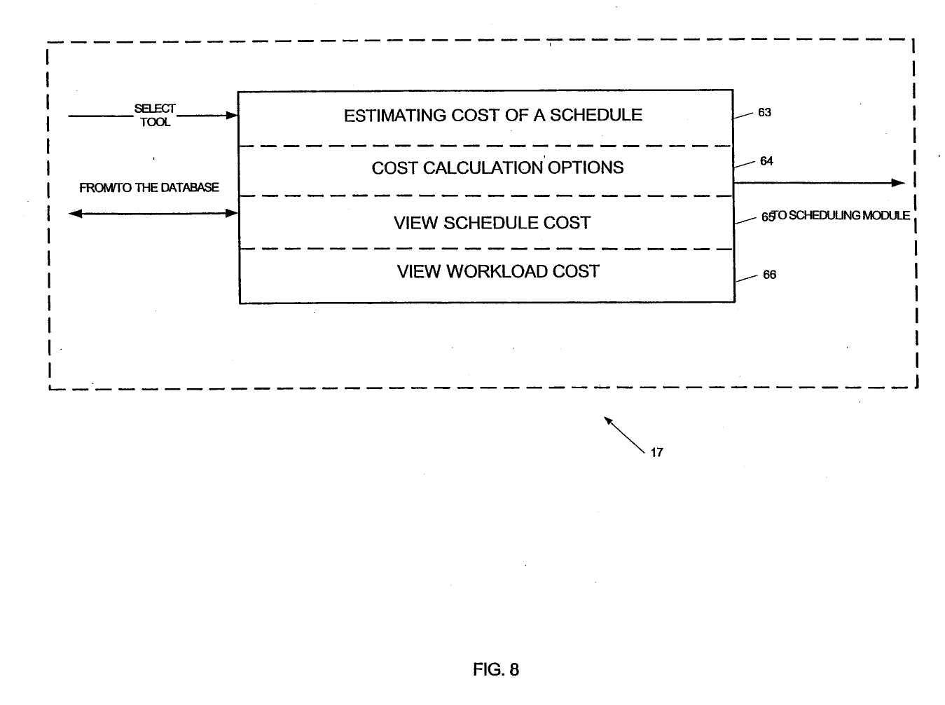

The Schedule Costing Module 17, FIG. 8 enables the user to analyze and control the labor cost of the scheduled workload volume. The Schedule Costing Module 17 is a rule based module. The user has the option of activating a default condition that applies predetermined rules to the workload volume or the user may select other conditions that have been predetermined by the user. The predetermined rules are activated via a Cost Calculation Option 64 tool. The Cost Calculation Option 64 enables the user to formulate the cost of overtime by selecting overtime thresholds, i.e., selecting shift premiums that extend beyond normal working hours, shift premiums for holiday events and selected shift multipliers that multiply standard shift costs by a selected number. The Cost Calculation Option's 64 overtime thresholds in concert with a known employee or class of labor force costs provide the user with an estimated payroll. The known employee or class of labor force is predetermined by the user. Information concerning an individual employee is stored on the Database 11. The stored information may, if desired, be name, employee number, hire date, seniority date telephone number, salary, salary period, exempt, non-exempt or any convenient information delineating the employment characteristics of the employee. A group of individual employees representing a particular skill level may, if desired, be formulated into a class of labor force.

The user may, if desired, view the cost of the schedule by activating the View Schedule Cost 65, FIG. 8 tool. The View Schedule Cost 65 displays the aggregation or calculation of the Schedule Costing Module 17. The display presented to the user is for a defined time period selected by the user. The schedule cost may, if desired, be delineated as costs of individual employees or classes of employees to perform work on the organization's behalf. The schedule further delineates detailed cost analysis with regard to regular salary, premium salary, overhead or any other convenient grouping of costs. A forecasted cost may, if desired, be viewed by the user by activating a View Workload Cost 66 tool, FIG. 8. The View Workload Cost 66 formulates a schedule cost by projecting into the future historical or modified historical costs of the labor force. The modified historical cost may, if desired, be selected by the user to reflect projected or known events that affect cost.

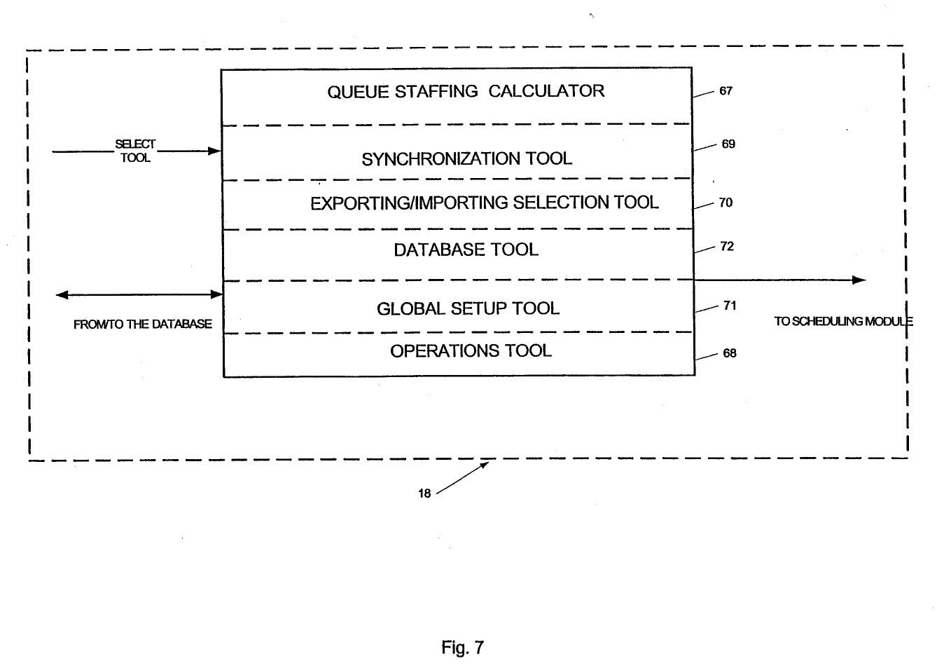

The Tool Module 18, FIG. 7 has a plurality of tools that are discussed in no particular order and may, if desired, be activated by the user at anytime. An Operations Tool 68 enables the user to produce printed reports, schedules, workload and cost. A Queue Staffing 67 enables the user to control time allotted to an individual performing a given task respective of a given customer satisfaction criteria. A Synchronization Tool 69 enables the user to synchronize remote systems in communication with the present invention 10. An Exporting/Importing tool 70 enables the user to transfer files, i.e., schedules, costing, etc. between remote systems and the present invention 10. A Global Setup Tool 71 enables the user to set-up and modify information in relation to schedule and cost. A Database Tool 72 enables the user to command and control all database functions known to those skilled in the art of database technology.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims, means-plus-function clause is intended to cover the structures described herein as performing the recited function and not only structural equivalents but also equivalent structures. All patents, applications and documents referred to herein are incorporated by reference in their entirety.

1-20. (canceled)

21. A method for scheduling resources, comprising:
receiving a work request, the work request including at least one parameter;
accessing a transactions database to obtain historical workload data for a plurality of scenarios;
analyzing said historical workload to provide a plurality of workload forecasts, each workload forecast being based upon said at least one parameter and upon one scenario of said plurality of scenarios;
accessing a resources availability database to obtain a schedule of available resources;
analyzing said schedule of available resources to provide a plurality of resource availability forecasts for the work request, each resource availability forecast being based upon one workload forecast of said plurality of workload forecasts; and
presenting at least one said resource availability forecast to a user, and
accepting a selection of said at least one resource availability forecast by said user and assigning resources to said work request upon the selected resource availability forecast.

22. The method of claim 21 wherein at least a portion of said plurality of scenarios are derived from said transactions database.

23. The method of claim 21 wherein at least one of said plurality of scenarios is a condition that affects the workload volume to be performed.

24. The method of claim 21 wherein the scenarios include at least one of: a department which may be affected by the forecast, employee name, employee group, trending data, deviation from average value, an exclusion value, data points of interest, financial data, a scenario name, or an excluded scenario name.

25. The method of claim 21 wherein the scenarios include at least one of: weather, geographical considerations, or political considerations.

26. The method of claim 21 wherein the scenarios include at least one of: a special event, a special date, a non-standard event, or an exception event.

27. The method of claim 21 wherein the step of presenting at least one said resource availability forecast to a user comprises presenting said plurality of resource availability forecasts to a user.

28. The method of claim 21 wherein:
the step of accessing a transactions database comprises obtaining historical workload data for a non-representative event; and
the step of providing a plurality of workload forecasts further comprises basing said workload forecasts upon said non-representative event.

29. The method of claim 21 wherein the scenarios include at least one of: a start date, a stop date, seasonal data, same week of the month, or an exclusion date.

30. A method for scheduling resources, comprising:
receiving a work request, the work request including at least one parameter;
accessing a transactions database to obtain historical workload data for a plurality of scenarios including at least one non-representative event,
analyzing said historical workload data, including said at least one non-representative event, to provide a plurality of workload forecasts, each workload forecast being based upon said at least one parameter, upon one scenario of said plurality of scenarios, and upon said at least one non-representative event;
accessing a resources availability database to obtain a schedule of available resources;
analyzing said schedule of available resources to provide a plurality of resource availability forecasts for the work request, each resource availability forecast being based upon one workload forecast of said plurality of workload forecasts; and
presenting said plurality of resource availability forecasts to a user; and
accepting a selection of a resource availability forecast by said user and assigning resources to said work request based upon the selected resource availability forecast.

31. The method of claim 30 wherein at least a portion of said plurality of scenarios are derived from said transactions database.

32. The method of claim 30 wherein at least one of said plurality of scenarios is a condition that affects the workload volume to be performed.

33. The method of claim 30 wherein the scenarios include at least one of: a department which may be affected by the forecast, employee name, employee group, trending data, deviation from average value, an exclusion value, data points of interest, financial data, a scenario name, or an excluded scenario name.

34. The method of claim 30 wherein the scenarios include at least one of: weather, geographical considerations, or political considerations.

35. The method of claim 30 wherein the non-standard event includes at least one of: a special event, a special date, or an exception event.
